(19) United States
(12) Patent Application Publication
(10) Pub. No.: US 2008/0123627 A1
(43) Pub. Date: May 29, 2008

(54) MEDIA TERMINAL ADAPTER WITH SESSION INITIATION PROTOCOL (SIP) PROXY

(76) Inventors: Charles S. Moreman, Grayson, GA (US); Marcin Godlewski, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/535,201

(22) Filed: Sep. 26, 2006

(51) Int. Cl. H04L 12/66; H04J 3/22

(52) U.S. Cl. 370/352; 370/467

(57) ABSTRACT

Systems and methods are disclosed for a media terminal adapter (MTA) that includes a session initiation protocol (SIP) to media gateway control protocol (MGCP) translator. The MTA receives SIP-based signaling packets including the MTA address and subsequently translates the signal packets to provide MGCP-based signaling packets. The MGCP-based signaling packets are subsequently transmitted to a communications network in order to set up a call where the associated voice packets are transmitted with QoS.

### FIELD OF THE INVENTION

This invention relates in general to telephony systems over broadband coaxial cable, and more particularly, to the field of enabling a session initiation protocol proxy in a media terminal adapter.

### DESCRIPTION OF THE RELATED ART

Media terminal adapters (MTAs) are the interface to the physical telephony or video equipment required for voice over Internet Protocol (VoIP) transport. Today, Data over Cable Service Interface Specification (DOCSIS) VoIP gateways, or embedded MTAs (EMTAs), which include both an MTA and a cable modem, provide quality of service (QoS) to voice calls that are generated by phones connected directly to the MTA. QoS is used to create quality of service transport guarantees for voice packets dynamically on a per call basis. QoS is used in the networks to ensure low latency and guaranteed bandwidth for voice packets typically using Real Time Protocol (RTP) for each phone call on the DOCSIS network. Since the DOCSIS network can become congested, QoS is used to ensure that VoIP calls are not impacted. When not needed for phone calls, the bandwidth that is not needed by high priority QoS packet flows can be used for lower priority packet flows such as web surfing and e-mail. MTAs using media gateway control protocol (MGCP) make use of significant infrastructure investment in MGCP equipment including support for QoS, MGCP softswitches, and provisioning servers. This infrastructure exists to ensure that MGCP-based phone calls receive preferred quality of service on the DOCSIS network and to control the packet switching of phone calls to MTA phone line endpoints and assign one or more phone numbers to each MTA endpoint.

Users may now use a session initiation protocol (SIP) phone, such as a WiFi (wireless fidelity) phone or a personal computer (PC) based phone. When the SIP-based phones are used with a conventional EMTA or cable modem for VoIP service, the audio phone call is carried over the DOCSIS network without the benefit of using any of the MGCP infrastructure available for MGCP phone calls. More specifically, the SIP-based phone calls face several limitations or restrictions. Users now making a call to or from a SIP-based phone are not able to use QoS so the voice packets from SIP-based phone calls compete with other Internet traffic, such as e-mail or web browsing, for bandwidth. Therefore, there is a need for a system and method that allows a SIP-based phone connection over the DOCSIS network while maintaining a QoS that is expected by the users.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 illustrates a communications system including a conventional telephone and a PC connected to an MTA for transporting voice and data packets over a communications network.

FIG. 2 illustrates a communications system including the conventional telephone, a SIP-based PC phone, and a WiFi SIP phone connected to an MTA for transporting packets over the communications network.

FIG. 3 illustrates a communications system including the conventional telephone, a SIP-based PC phone, and a WiFi SIP phone connected to an MTA including an SIP to MGCP translator in accordance with the present invention.

FIG. 4 illustrates a processor within the MTA with the SIP to MGCP translator in accordance with the present invention.

FIG. 5 illustrates routing information attached to generated SIP-based signaling packets based on conventional routing information and present invention routing information.

### DETAILED DESCRIPTION OF THE PREFERRED EMBODIMENT

Preferred embodiments of the invention can be understood in the context of a broadband communications system. Note, however, that the invention may be embodied in many different forms and should not be construed as limited to the embodiments set forth herein. All examples given herein, therefore, are intended to be non-limiting and are provided in order to help clarify the description of the invention.

The present invention is directed towards a system and method for transmitting voice packets having QoS that are generated from SIP-based telephones over a DOCSIS communications network. Importantly, the SIP-based phone calls can use network infrastructure designed for MGCP-based phone calls. More specifically, an MTA receives SIP call signaling packets and subsequently translates the SIP call signaling packets into MGCP call signaling packets. The translated MGCP call signaling packets then set up QoS with security for the voice RTP packets. This is advantageous over the conventional method of routing voice packets from SIP-based telephones where the SIP voice packets compete for bandwidth with other Internet traffic and are unable to use the infrastructure that is available to MGCP voice packets. MGCP voice packets that are received from a conventional telephone are also transmitted through the MTA having QoS in a known manner.

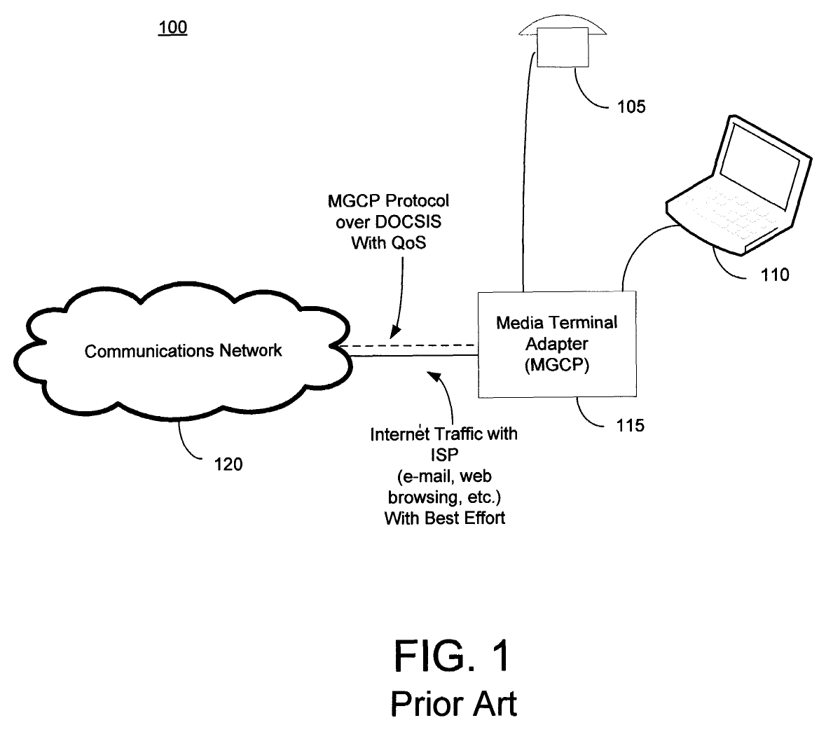

FIG. 1 illustrates a communications system 100 including a conventional telephone 105 and a PC 110 connected to an MTA 115 for transporting voice and data packets over a communications network 120. The telephone 105 is physically connected to the MTA 115 using standard wiring and telephone jacks, such as CAT-3 and RJ11 connectors. Voice signals received from the telephone 105 are packetized by the MTA 115. The voice packets are then transmitted over the communications network 120 using an MGCP protocol over DOCSIS to a cable modem termination system (CMTS). Importantly, the voice packets are transmitted over the communications network 120 having QoS, which is illustrated by the dotted lines between the MTA 115 and the communications network 120.

The PC 110 is generally connected to the MTA 115 with an Ethernet cable and Ethernet plugs and jacks although it may also be connected with a wireless gateway. Data packets are transmitted to and received from the MTA 115. The data packets are transmitted and received from the communications network 120 using Internet addresses in a known manner. The data packets, such as e-mail and web browsing, are transmitted over the communications network 120 with a best effort. In other words, the Internet traffic, which is enabled by an Internet Services Provider (ISP), does not have QoS, which is illustrated by the solid lines between the MTA 115 and the communications network 120.

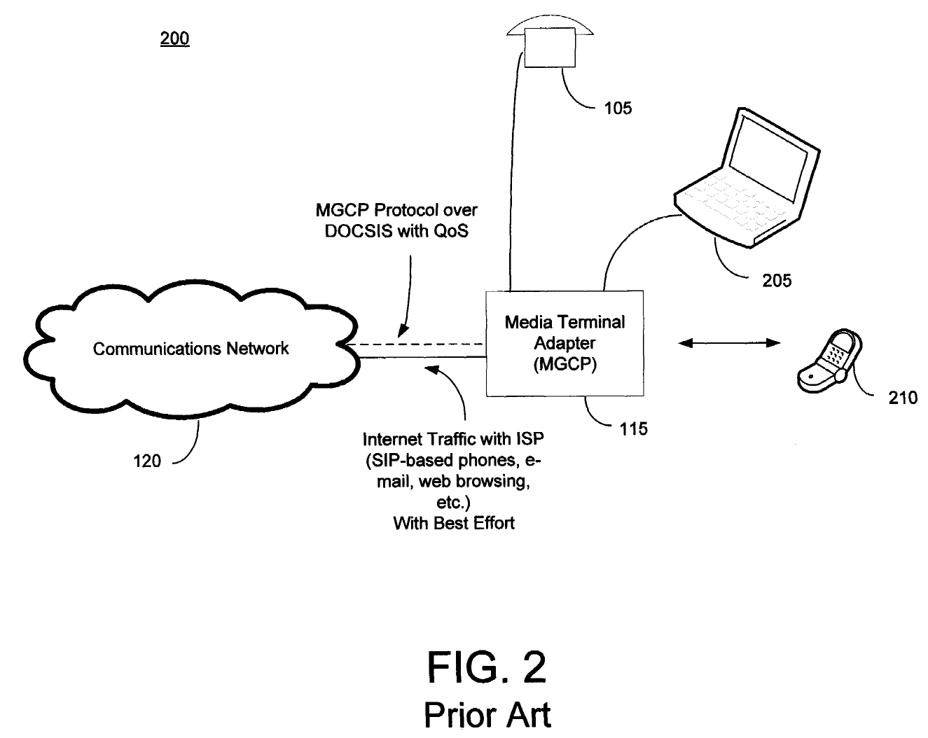

FIG. 2 illustrates a communications system 200 including the conventional telephone 105, a SIP-based PC phone 205, and a WiFi SIP phone 210 connected to the MTA 115 for transporting signaling, voice, and data packets over the communications network 120. The SIP-based signaling packets set up the call; for example, dialing a telephone number and setting up the call by using a session description protocol (SDP), which describes where the voice packets are being transmitted. The voice packets are then transmitted via RTP packets the intended receiver. In this implementation, the signaling, voice, and data packets include a destination Internet address of the intended receiving telephone or computer, and are transmitted over an Ethernet cable to the MTA 115. The MTA 115 then forwards the packets to the communications network 120, which are then combined with all the Internet traffic with only a best effort.

The WiFi SIP phone 210 generates signaling and voice packets, including a destination address of an intended receiving telephone or computer, and are transmitted and received by an antenna (not shown) in the MTA 115. The MTA 115 then forwards the signaling and voice packets to the communications network 120. In this manner, the SIP signaling sets up the call, and the voice packets are then combined with other Internet traffic with only a best effort. Disadvantageously, the voice packets without QoS may be dropped at any time or delayed during the telephone conversation, which degrades the quality of the voice communication heard by both the caller and the receiver.

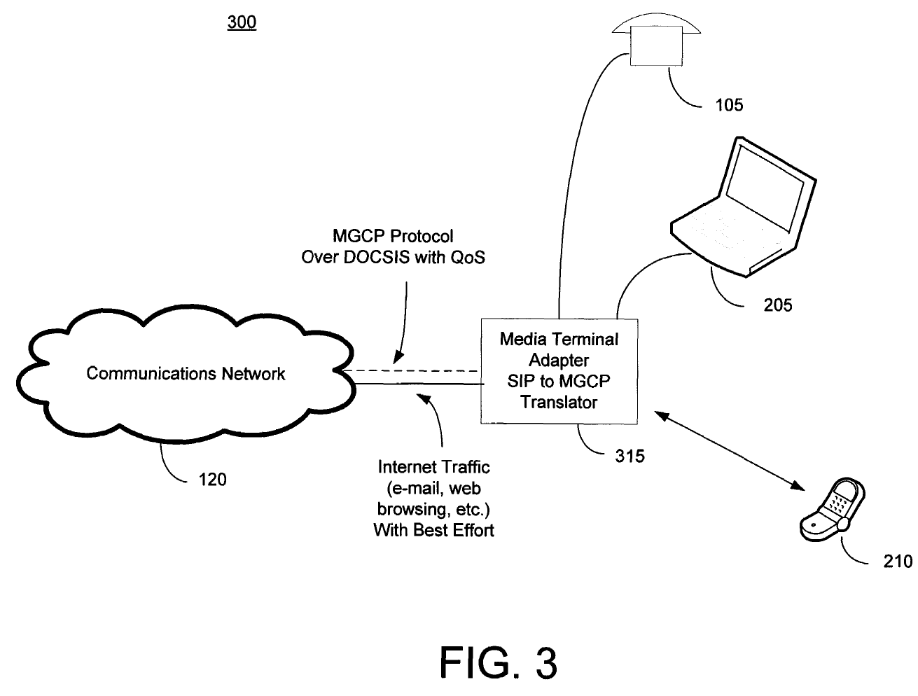

FIG. 3 illustrates a communications system 300 including the conventional telephone 105, the SIP-based PC phone 205, and a WiFi SIP phone 210 connected to an MTA 315, where the MTA 315 includes an SIP to MGCP translator in accordance with the present invention. The telephone 105 transmits MGCP-based signaling packets, and the voice packets are transmitted in the same manner as described above in connection with FIGS. 1 and 2. The SIP-based PC phone 205 generates SIP-based signaling packets that are transmitted to the MTA 315. In accordance with the present invention, the MTA 315 translates the SIP-based signaling packets to MGCP-based signaling packets. The translated MGCP-based signaling packets then set up the call for the voice RTP packets using the MGCP infrastructure including security parameters. The voice RTP packets are subsequently transmitted over DOCSIS with QoS, which is illustrated by the dotted lines connecting the MTA 315 and the communications network 120. SIP-based data signals generated by the PC 205 are routed over the communications network 120 via the MTA 315 with a best effort and are represented as the solid lines. Additionally, SIP-based signaling packets generated by the WiFi SIP phone 210 are transmitted to the MTA 315, which then translates the SIP-based signaling packets to MGCP-based signaling packets. The translated MGCP-based signaling packets then set up the call having QoS for the voice RTP packets, which follows the dotted line connecting the MTA 315 and the communications network 120.

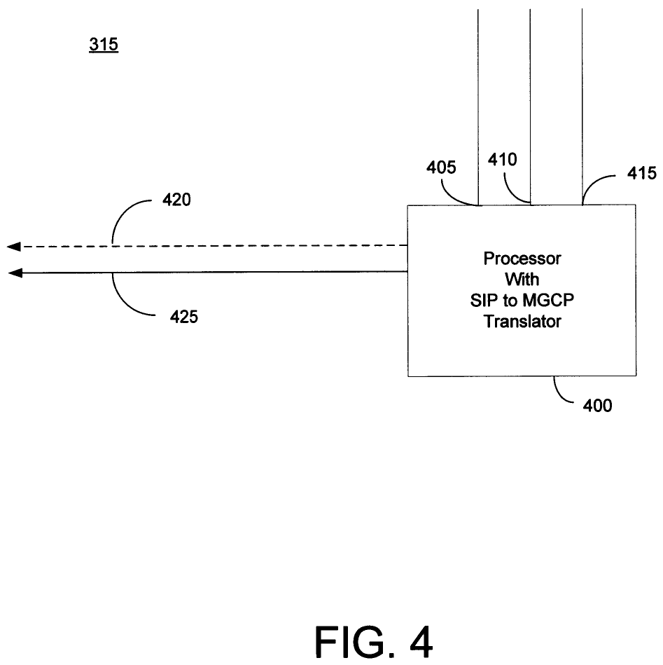

FIG. 4 illustrates a processor 400 within the MTA 315 with the SIP to MGCP translator in accordance with the present invention. The processor 400 includes software and hardware for translating the SIP-based signaling packets into the MGCP-based signaling packets. A first receiver point 405 is coupled to the conventional telephone 105 that is used for generating MGCP-based signaling and voice packets. A second receiver point 410 is coupled to the SIP-based PC phone 205 that receives SIP-based signaling, voice, and data packets. A third receiver point 415 is coupled to the WiFi SIP phone 210 that wirelessly receives SIP-based signaling and voice packets. The SIP-based signaling packets received from both the SIP-based PC phone 205 and the WiFi SIP phone 210 are translated to MGCP-based signaling packets by the SIP to MGCP translator. After translation, the MGCP-based signaling packets then set up the call using the MGCP infrastructure including QoS. The voice packets are associated with the translated MGCP-based signaling packets are routed to the communications network 120 having QoS, which is illustrated by dotted line 420. As mentioned, the data packets continue transmission through the communications network 120 with a best effort, which is illustrated by the solid line 425.

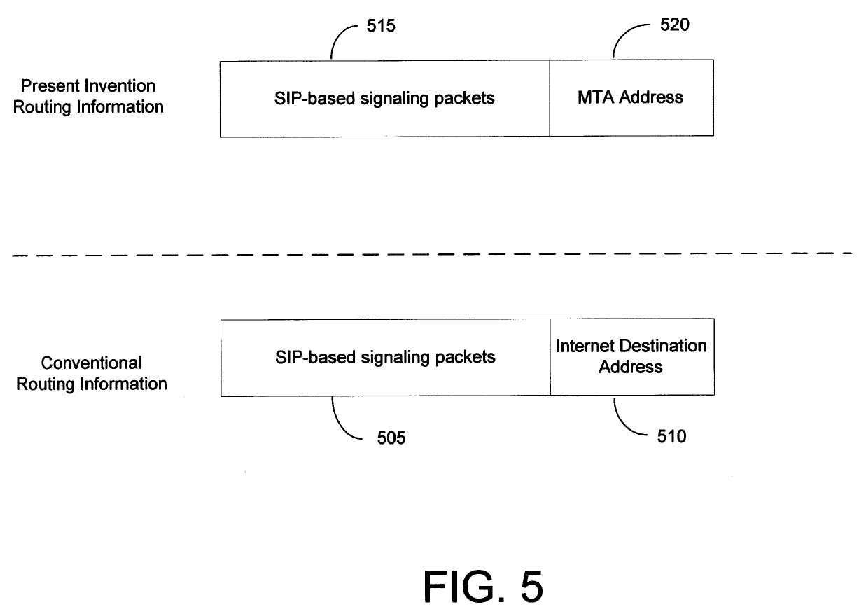

FIG. 5 illustrates routing information attached to generated SIP-based signaling packets based on conventional routing information and present invention routing information. Conventionally, the SIP-based signaling packets 505 include a destination Internet address in attached header information. Accordingly, the SIP-based signaling packets 505 for setting up the call are forwarded via the MTA 115 (FIG. 2) to the intended receiver using the destination Internet address. In this manner, the SIP-based signaling packets 505, and subsequently, the voice packets are routed with only a best effort (i.e., without QoS).

In accordance with the present invention, however, the destination address for generated SIP-based signaling packets 515 now reflects an address associated with the MTA 315. The destination address of the MTA 315 is programmed into the PC 205 and the WiFi phone 210 either by a user of the equipment or a service provider. When the MTA 315 receives the SIP-based signaling packets 515 including its address as the destination, the MTA 315 provides the SIP-based signaling packets 515 to the SIP to MGCP translator 400 for conversion. Subsequently, the translated MGCP-based signaling packets then set up the call using the MGCP infrastructure for the voice packets. The SIP-based data packets 525 from the PC 205 include an Internet destination address 530 so that the MTA 315 continues to forward these packets 525 to the communications network 120 with a best effort.

Accordingly, systems and methods have been provided that allows transmission of SIP-based voice packets having QoS. It will be appreciated that further embodiments are envisioned that implement the invention, for example, using all software or adding modes for additional features and services.

What is claimed is:

1. A media terminal adapter (MTA) having an MTA address, comprising: a SIP to MGCP signaling translator,
wherein, when the MTA receives SIP-based signaling packets including its MTA address, the SIP to MGCP signaling translator translates the SIP-based signaling packets to MGCP-based signaling packets.

2. The MTA of claim 1, wherein the MGCP-based signaling packets set up QoS for associated voice packets.

3. The MTA of claim 1, wherein the MTA receives SIP-based data packets including an Internet address, wherein the MTA provides the SIP-based data packets to the communications network, wherein the data packets are transmitted with best effort.

4. The MTA of claim 1, further comprising a processor including software for translating the SIP-based signaling packets to the MGCP-based signaling packets.

5. The MTA of claim 1, wherein the SIP-based signaling packets and MTA address are provided by at least one of a SIP-based personal computer telephone or a SIP-based telephone, wherein the MTA address of the coupled MTA is preprogrammed into the at least one SIP-based personal computer telephone and SIP-based telephone.

6. The MTA of claim 1, wherein the MTA receives MGCP-based signaling packets having a destination address of an intended receiver from an MGCP telephone, and wherein the MTA provides the MGCP-based signaling packets to the communications network with QoS.

7. A method of receiving SIP-based signaling packets, wherein associated voice packets are transmitted over a communications network having QoS, the method comprising the steps of:
receiving a plurality of packets at an media terminal adapter (MTA) from coupled devices:
determining whether or not an address associated with the MTA is included in received SIP-based signaling packets;
if the MTA address is included, translating the SIP-based signaling packets to MGCP-based signaling packets; and
providing the translated MGCP-based signaling packets to the communications network,
wherein the translated MGCP-based signaling packets set up QoS for the associated voice packets.

8. The method of claim 7, further comprising the steps of:
preprogramming the MTA address of the coupled MTA into the coupled devices;
generating the SIP-based signaling packets including MTA address specifying the MTA from at least one of the coupled devices, wherein the coupled devices may include a SIP-based telephone or computer; and
transmitting the SIP-based signaling packets to the MTA.

9. The method of claim 7, the steps further comprising:
receiving MGCP-based signaling packets having a destination address from a telephone; and
providing the MGCP-based signaling packets to the communications network, wherein the MGCP-based signaling packets have QoS.

10. The method of claim 7, the steps further comprising:
receiving data packets including a destination address from a computer; and
providing the data packets to the communications network, wherein the data packets are combined with further Internet traffic and transmitted with best effort.

11. A communications system, comprising:
a SIP-based telephone for generating SIP-based signaling packets including an MTA address, wherein the MTA address is associated with a coupled MTA, and is preprogrammed into the SIP-based telephone;
the coupled MTA for receiving the SIP-based signaling packets, and, when the SIP-based signaling packets include the MTA address, the coupled MTA for translating the SIP-based signaling packets into MGCP-based signaling packets; and
a communications network for receiving and transmitting the translated MGCP-based signaling packets, wherein the translated MGCP-based signaling packets set up a call for associated voice packets having QoS.

12. The communications system of claim 11, the MTA comprising a SIP to MGCP translator for translating the SIP-based signaling packets into MGCP-based signaling packets when the SIP-based signaling packets include the MTA address.

13. The communications system of claim 11, further comprising:
a conventional telephone for generating MGCP-based signaling packets having a destination address, wherein the MTA receives the MGCP-based signaling packets and forwards them to the communications network for transmission with QoS.

14. The communications system of claim 11, wherein the SIP-based telephone is at least one of a PC telephone, a wired telephone, and a wireless fidelity (WiFi) telephone.

15. The communications system of claim 11, wherein the SIP-based telephone is programmed to generate SIP-based signaling packets including the preprogrammed MTA address.

16. The communications system of claim 11, wherein the MTA receives data packets having an Internet destination address, and wherein the MTA forwards the data packets to the communications network for transmission with best effort.

17. A communications system for transmitting voice and data packets, the communications system comprising:
a personal computer (PC) for generating SIP-based signaling packets including a preprogrammed MTA address and data packets having an Internet destination address;
an MTA having the MTA address for receiving the SIP-based signaling packets and the data packets, wherein, when the MTA recognizes the MTA address, the MTA translates the SIP-based signaling packets to MGCP-based signaling packets, and wherein the MTA forwards the data packets to a communications network,
wherein the translated MGCP-based signaling packets set up a call for associated voice packets transmitted with QoS, and wherein the data packets are transmitted with best effort.

18. The communications system of claim 17, further comprising:
a telephone for generating MGCP-based signaling packets having a receiving destination address, wherein the MTA forwards the MGCP-based signaling packets to the communications network in order to set up a call having QoS.

19. The communications system of claim 17, further comprising:
a SIP-based WiFi telephone for generating SIP-based signaling packets including the preprogammed MTA address, wherein, when the MTA recognizes the MTA address, the MTA translates the SIP-based signaling packets into MGCP-based signaling packets.

20. The communications system of claim 19, wherein the translated SIP-based signaling packets from the WiFi telephone set up a telephone call with QoS.
